(19) United States
(12) Patent Application Publication
(10) Pub. No.: US 2014/0011516 A1
(43) Pub. Date: Jan. 9, 2014

(54) METHOD AND APPARATUS FOR ESTIMATING LOCATION OF TERMINAL USING GENERATION OF VIRTUAL INFRASTRUCTURES

(71) Applicant: Electronics and Telecommunications Research Institute, Daejeon (KR)

(72) Inventors: Myung-In JI, Daejeon (KR); Young-Su CHO, Seoul (KR); Sang-Joon PARK, Daejeon (KR)

(21) Appl. No.: 13/918,634

(22) Filed: Jun. 14, 2013

(30) Foreign Application Priority Data
Jul. 4, 2012 (KR) 10-2012-0072642

(51) Int. Cl. H04W 4/04

(52) U.S. Cl. CPC H04W 4/04
USPC 455/456.1

(57) ABSTRACT

Disclosed herein is a method and apparatus for estimating the location of a terminal using the generation of virtual infrastructures. In the method of estimating the location of a terminal using the generation of virtual infrastructures according to the present invention, an initially estimated location of a terminal is calculated using a plurality of installed infrastructures. A plurality of virtual infrastructures are generated by symmetrically moving the plurality of infrastructures with respect to the initially estimated location of the terminal. The initially estimated location of the terminal is corrected using the plurality of infrastructures and the plurality of virtual infrastructures, and then the corrected estimated location of the terminal is recalculated.

### CROSS REFERENCE TO RELATED APPLICATION

This application claims the benefit of Korean Patent Application No. 10-2012-0072642, filed on Jul. 4, 2012, which is hereby incorporated by reference in its entirety into this application.

### BACKGROUND OF THE INVENTION

1. Technical Field

The present invention relates generally to a method and apparatus for estimating the location of a terminal using the generation of virtual infrastructures and, more particularly, to a method and apparatus for estimating the location of a terminal using the generation of virtual infrastructures, which generate a plurality of virtual infrastructures and calculate a more accurate location by complexly utilizing the virtual infrastructures and information about actual installed infrastructures when estimating the location based on the signal intensities of the infrastructures, so that when the terminal is located in a border area defined by the infrastructures or the outer area thereof, more precise location accuracy can be simply obtained by merely revising an algorithm without installing an additional infrastructure or modifying a distance measurement method or the like.

2. Description of the Related Art

Location estimation technology using wireless communication infrastructures is present in various forms depending on the type of infrastructures and the coverage of services.

A Global Navigation Satellite System (GNSS) refers to a system for determining the location of a user using satellite signals sent to the earth by orbiting satellites. Several GNSSs, such as the Global Positioning System (GPS) of the United States, the Global Navigation Satellite System (or Global Orbiting Navigation Satellite System: GLONASS) of Russia, the Galileo of Europe, etc. are currently being operated or are scheduled to be operated. Such a GNSS includes a satellite unit arranged to cover the overall area of the earth and configured to transmit signals including precise time information and satellite orbit information, a reception unit configured to receive four or more satellite signals and calculate a location, and a ground control unit configured to monitor and control the states and orbits of satellites.

A GNSS provides high location accuracy and availability with an error margin of 10 m or less on level ground or on the outskirts of a city where the direct line of sight of the satellite unit and the reception unit is secured. However, in a congested metropolitan area that is a non-line-of-sight area, the margin of error for location accuracy reaches 50 m due to a multi-path error. Especially in an indoor area, reception signal sensitivity is deteriorated, so that signals cannot be obtained, thus making it impossible to determine the location.

Cellular-based location estimation technology is technology for determining the location of a user using the location information and measured signals of a mobile communication base station. In detail, such cellular-based location estimation technology is classified into Cell-Identification (Cell-ID), Enhanced-Observed Time Difference (E-OTD), Advanced-Forward Link Trilateration (AFLT), etc. depending on the number of base stations from which a terminal can receive signals. This technology is advantageous in that a location can be determined even in indoor areas, as well as in outdoor areas, thanks to the characteristics of mobile communication infrastructures being that most areas, including metropolitan areas and the outskirts of a city, are within service coverage. However, the accuracy of location estimation differs depending on the density of arranged base stations and a relatively low location accuracy with an error margin of about 100˜800 m is obtained on average, thus making it difficult to apply this technology to indoor/outdoor navigation services or the like requiring a location accuracy with an error margin of about several m.

Assisted-GNSS (AGNSS) denotes technology for obtaining assistant information from a location estimation server so as to improve the minimum reception signal sensitivity of a GNSS receiver contained in a terminal and shorten an initial location determination time (Time To First Fix). This technology enables rapid location determination using GNSS in a congested metropolitan area belonging to a weak signal environment, but makes it difficult to obtain a high level of effectiveness in an indoor area because signal intensity is very weak in the indoor area.

Wireless Fidelity (Wi-Fi)-based location estimation technology, which is a representative method of overcoming the difficulty of indoor location estimation, is a method of calculating the location of a terminal using a database including the identifiers of Wi-Fi Access Points (APs), reference locations, etc., and measured values of the Wi-Fi APs received by the terminal. Such a method can be classified, depending on targets to be applied and systems to be constructed, into a method of configuring and utilizing a radiomap for Wi-Fi APs for respective reference points of service target areas, and a method of estimating the location of a terminal by assigning weights to the intensities of Wi-Fi AP signals received by the terminal in contrast with the locations of the APs.

Generally, the method of configuring and utilizing the radiomap determines location accuracy in proportion to the density of reference points regardless of the number of installed Wi-Fi APs. However, since the configuration of the radiomap requires a lot of effort and the radiomap has a large capacity, there is a disadvantage in that it is difficult to utilize such a radiomap in normal terminals. In contrast, the method of performing calculation using weights relative to the intensities of signals received from the Wi-Fi APs can be easily utilized even in normal terminals because the computational load thereof is low. However, this method may cause problems, such as the problem of a border area effect in which accuracy is decreased in an area in which a small number of Wi-Fi APs are installed, or near the border of the area in which Wi-Fi APs are installed.

### SUMMARY OF THE INVENTION

Accordingly, the present invention has been made keeping in mind the above problems occurring in the prior art, and an object of the present invention is to provide a method and apparatus for estimating the location of a terminal using the generation of virtual infrastructures, which generate a plurality of virtual infrastructures and calculate a more accurate location by complexly utilizing the virtual infrastructures and information about actual installed infrastructures when estimating the location based on the signal intensities of the infrastructures, so that when the terminal is located in a border area defined by the infrastructures or the outer area thereof, more precise location accuracy can be simply obtained by merely revising an algorithm without installing an additional infrastructure or modifying a distance measurement method or the like.

In accordance with an aspect of the present invention to accomplish the above object, there is provided a method of estimating a location of a terminal using generation of virtual infrastructures, including calculating an initially estimated location of a terminal using a plurality of installed infrastructures; generating a plurality of virtual infrastructures by symmetrically moving the plurality of infrastructures with respect to the initially estimated location of the terminal; and correcting the initially estimated location of the terminal using the plurality of infrastructures and the plurality of virtual infrastructures, and then recalculating the corrected estimated location of the terminal.

Preferably, the method may further include eliminating virtual infrastructures enclosed by the plurality of infrastructures from the plurality of virtual infrastructures.

Preferably, the recalculating the corrected estimated location of the terminal may be configured to correct the initially estimated location of the terminal using the plurality of infrastructures and virtual infrastructures, except the eliminated virtual infrastructures among the plurality of virtual infrastructures, and then recalculate the corrected estimated location of the terminal.

Preferably, the calculating the initially estimated location of the terminal may be configured to calculate the initially estimated location of the terminal either by using only some infrastructures around the terminal among the plurality of infrastructures or by using only one infrastructure among the plurality of infrastructures.

In accordance with another aspect of the present invention to accomplish the above object, there is provided an apparatus for estimating a location of a terminal using generation of virtual infrastructures, including an initially estimated location calculation unit for calculating an initially estimated location of the terminal using a plurality of installed infrastructures; a virtual infrastructure generation unit for generating a plurality of virtual infrastructures by symmetrically moving the plurality of infrastructures with respect to the initially estimated location of the terminal; and a corrected estimated location calculation unit for correcting the initially estimated location of the terminal using the plurality of infrastructures and the plurality of virtual infrastructures, and then recalculating the corrected estimated location of the terminal.

Preferably, the virtual infrastructure generation unit may eliminate virtual infrastructures enclosed by the plurality of infrastructures from the plurality of virtual infrastructures.

Preferably, the corrected estimated location calculation unit may correct the initially estimated location of the terminal using the plurality of infrastructures and virtual infrastructures, except the eliminated virtual infrastructures among the plurality of virtual infrastructures, and then recalculate the corrected estimated location of the terminal.

Preferably, the initially estimated location calculation unit may calculate the initially estimated location of the terminal either by using only some infrastructures around the terminal among the plurality of infrastructures or by using only one infrastructure among the plurality of infrastructures.

Preferably, the plurality of infrastructures may be Wi-Fi access points.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a typical example of a location estimation method using weights relative to the intensities of signals received from infrastructures;

FIG. 2 is a diagram showing an example in which a large error occurs in the location estimation method using weights relative to the intensities of signals received from the infrastructures;

FIG. 3 is a flowchart showing a method of estimating the location of a terminal using the generation of virtual infrastructures according to an embodiment of the present invention;

FIG. 4 is a flowchart showing a method of estimating the location of a terminal using the generation of virtual infrastructures according to another embodiment of the present invention;

FIG. 5 is a block diagram schematically showing an apparatus for estimating the location of a terminal using the generation of virtual infrastructures according to an embodiment of the present invention;

FIG. 6 is a diagram showing an example of a location estimation scenario in which the method and apparatus for estimating the location of a terminal using the generation of virtual infrastructures can be used according to an embodiment of the present invention;

FIGS. 7 to 10 are diagrams showing an example of a process for estimating the location of a terminal by utilizing the method and apparatus for estimating the location of the terminal using the generation of virtual infrastructures according to the embodiment of the present invention; and

FIGS. 11 to 14 are diagrams showing another example of a process for estimating the location of a terminal by utilizing the method and apparatus for estimating the location of the terminal using the generation of virtual infrastructures according to the embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

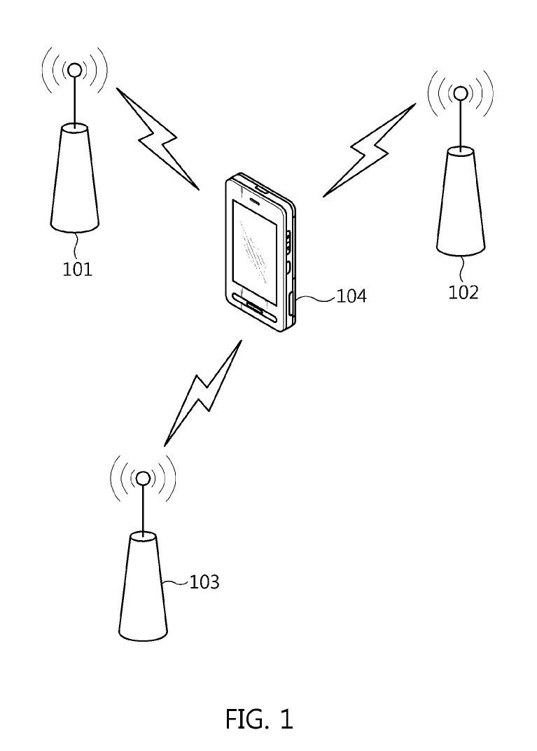

FIG. 1 is a diagram showing a typical example of a location estimation method using weights relative to the intensities of signals received from infrastructures.

The method shown in FIG. 1 is a scheme in which a terminal 104 receives signals from infrastructures 101 to 103, the locations of which are known, assigns proportional weights to infrastructures having stronger signals among the received signals, and then estimates the current location of the terminal 104. When signals having identical intensities are received from all of the infrastructures 101 to 103, a location corresponding to the center of locations at which the infrastructures 101 to 103 are installed is estimated as the location of the terminal 104.

Since this method, compared to other location estimation techniques, requires a smaller database (DB) for estimation and has a lower computational load for algorithms, it is widely used to estimate the location of a specific node or a specific terminal in an area in which sensors are uniformly installed, or to rapidly estimate the location of a terminal, such as a mobile device (for example, a smart phone) in a place in which a large number of infrastructures are installed.

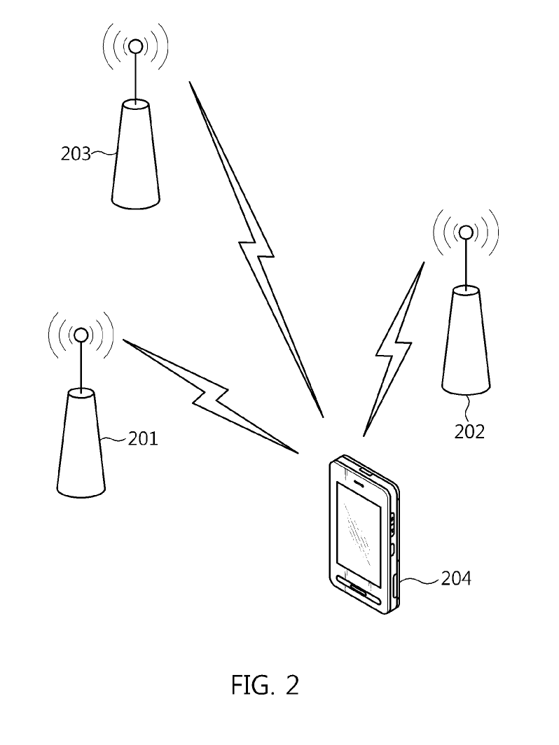

However, in some environments, such as an environment in which infrastructures do not enclose the terminal, this method causes a large error, and such a case will be described in detail below with reference to FIG. 2.

FIG. 2 is a diagram showing an example in which a large error occurs in the location estimation method using weights relative to the intensities of signals received from the infrastructures.

Referring to FIG. 2, a terminal 204 is present outside an area enclosed by infrastructures 201 to 203. In the conventional method using weights relative to signal intensities based on the locations of infrastructures, the location of the terminal 204 is estimated to be always within the area enclosed by the infrastructures. That is, the example shown in FIG. 2 corresponds to a case where an error occurs in the structure of the algorithm. Such an error can be solved by generating virtual infrastructures in the present invention.

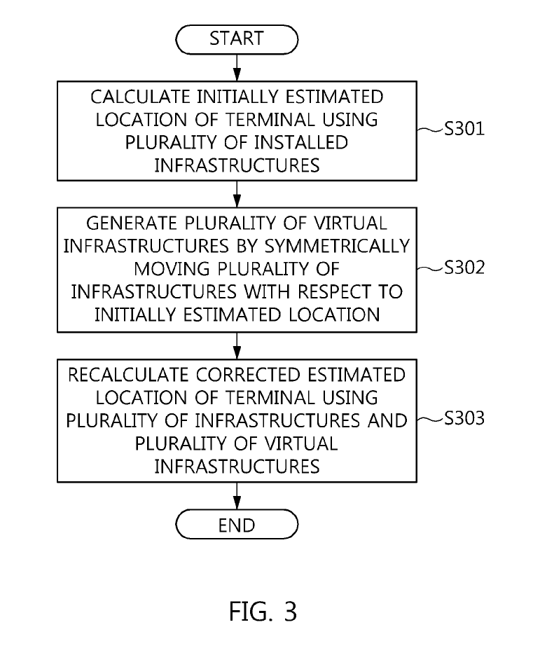

FIG. 3 is a flowchart showing a method of estimating the location of a terminal using the generation of virtual infrastructures according to an embodiment of the present invention.

Referring to FIG. 3, when a method of estimating the location of a terminal using the generation of virtual infrastructures according to an embodiment of the present invention is initiated, the initially estimated location of the terminal is calculated using a plurality of installed infrastructures at step S301. In this case, the initially estimated location of the terminal can be calculated either by using only some infrastructures around the terminal among the plurality of infrastructures or by using only one infrastructure among the plurality of infrastructures. The plurality of infrastructures may be Wi-Fi Access Points (APs). Further, the infrastructures may include conventional communication infrastructures and may also include communication infrastructures to be developed in the future.

Then, a plurality of virtual infrastructures are generated by symmetrically moving the plurality of infrastructures with respect to the initially estimated location of the terminal at step S302.

Thereafter, the initially estimated location of the terminal is corrected using the plurality of infrastructures and the plurality of virtual infrastructures, and then the corrected estimated location of the terminal is recalculated at step S303.

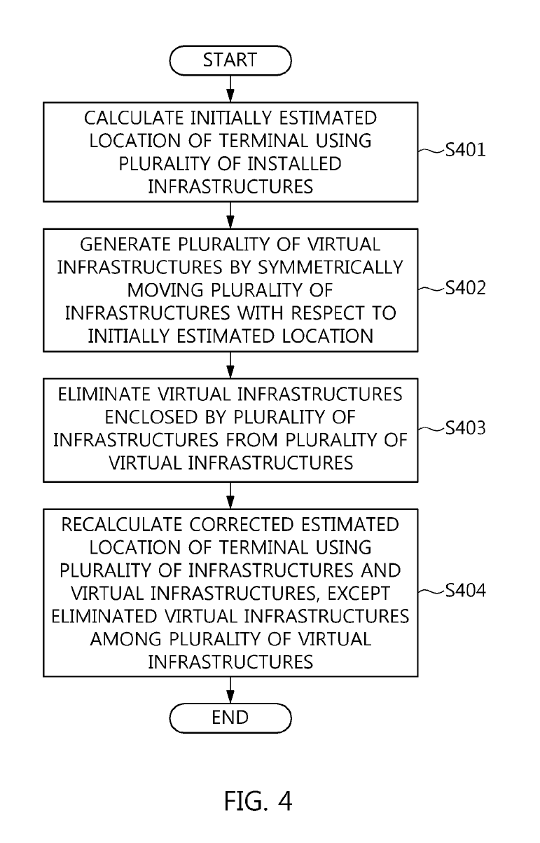

FIG. 4 is a flowchart showing a method of estimating the location of a terminal using the generation of virtual infrastructures according to another embodiment of the present invention.

Referring to FIG. 4, when a method of estimating the location of a terminal using the generation of virtual infrastructures according to another embodiment of the present invention is initiated, the initially estimated location of the terminal is calculated using a plurality of installed infrastructures at step S401. In this case, the initially estimated location of the terminal can be calculated either by using only some infrastructures around the terminal among the plurality of infrastructures or by using only one infrastructure among the plurality of infrastructures.

Further, a plurality of virtual infrastructures are generated by symmetrically moving the plurality of infrastructures with respect to the initially estimated location of the terminal at step S402, and virtual infrastructures enclosed by the plurality of infrastructures are eliminated from the plurality of virtual infrastructures at step S403.

Thereafter, the initially estimated location of the terminal is corrected using the plurality of infrastructures and the virtual infrastructures, except the eliminated virtual infrastructures among the plurality of virtual infrastructures, and then the corrected estimated location of the terminal is recalculated at step S404.

The above-described method of estimating the location of the terminal using the generation of virtual infrastructures has been described with reference to the flowcharts presented in the drawings. Although the method has been described as being a series of blocks for the sake of simplicity of explanation, the present invention is not limited by the sequence of the blocks, and several blocks may occur either in a sequence different from that shown and described in the present specification with respect to other blocks, or simultaneously with other blocks. Further, a variety of different branches, flow paths and block sequences that achieve results identical or similar to those of the present specification may be implemented. Furthermore, all blocks shown in the implementation of the method described in the present specification may not necessarily be required.

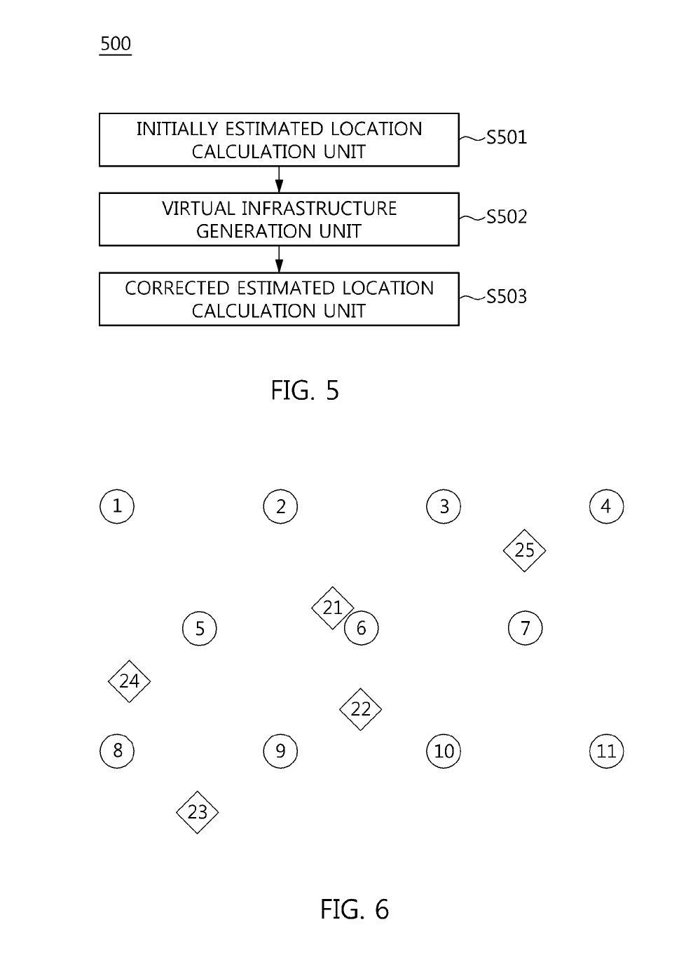

FIG. 5 is a block diagram schematically showing an apparatus for estimating the location of a terminal using the generation of virtual infrastructures according to an embodiment of the present invention.

Referring to FIG. 5, an apparatus 500 for estimating the location of a terminal using the generation of virtual infrastructures according to an embodiment of the present invention may include an initially estimated location calculation unit 501, a virtual infrastructure generation unit 502, and a corrected estimated location calculation unit 503. The apparatus 500 for estimating the location of the terminal using the generation of virtual infrastructures, shown in FIG. 5, corresponds to one embodiment. All blocks shown in FIG. 5 are not essential components, and some blocks may be added, changed or deleted in other embodiments.

The initially estimated location calculation unit 501 calculates the initially estimated location of the terminal using a plurality of installed infrastructures. In this case, the initially estimated location calculation unit 501 can calculate the initially estimated location of the terminal either by using only some infrastructures around the terminal among the plurality of infrastructures or by using only one infrastructure among the plurality of infrastructures. The plurality of infrastructures may be Wi-Fi Access Points (APs). Further, the plurality of infrastructures may include conventional communication infrastructures and may also include communication infrastructures to be developed in the future.

The virtual infrastructure generation unit 502 generates a plurality of virtual infrastructures by symmetrically moving the plurality of infrastructures with respect to the initially estimated location of the terminal. In an embodiment, the virtual infrastructure generation unit 502 may eliminate virtual infrastructures enclosed by the plurality of infrastructures from the plurality of virtual infrastructures.

The corrected estimated location calculation unit 503 corrects the initially estimated location of the terminal using the plurality of infrastructures and the plurality of virtual infrastructures, and then recalculates the corrected estimated location of the terminal. In an embodiment, when the virtual infrastructure generation unit 502 eliminates virtual infrastructures enclosed by the plurality of infrastructures from the plurality of virtual infrastructures, the corrected estimated location calculation unit 503 can correct the initially estimated location of the terminal using the plurality of infrastructures and virtual infrastructures, except the eliminated virtual infrastructures among the plurality of virtual infrastructures, and can then recalculate the corrected estimated location of the terminal.

The apparatus 500 for estimating the location of the terminal using the generation of virtual infrastructures according to the embodiment of the present invention, which has been described with reference to FIG. 5, may be included in the terminal used by the user or implemented as a separate device and may estimate the location of the terminal.

FIG. 6 is a diagram showing an example of a location estimation scenario in which the method and apparatus for estimating the location of a terminal using the generation of virtual infrastructures can be used according to an embodiment of the present invention.

The scenario shown in FIG. 6 is an example in which a total of 11 infrastructures 1 to 11 are actually installed and five terminals 21 to 25 estimate the locations of the terminals using the infrastructures 1 to 11.

In FIG. 6, since the terminals 21, 22, and 25 are enclosed by the infrastructures 1 to 11, they are present in places in which the locations thereof can be relatively accurately estimated when the location estimation method using weights relative to the intensities of signals received from infrastructures is used. However, since the terminals 23 and 24 are not enclosed by the infrastructures 1 to 11, they are present in places in which a large error can occur. Below, the case where each of the terminals 23 and 24 estimates its location by utilizing the method and apparatus for estimating the location of the terminal using the generation of virtual infrastructures according to the embodiment of the present invention will be described in detail with reference to the attached drawings.

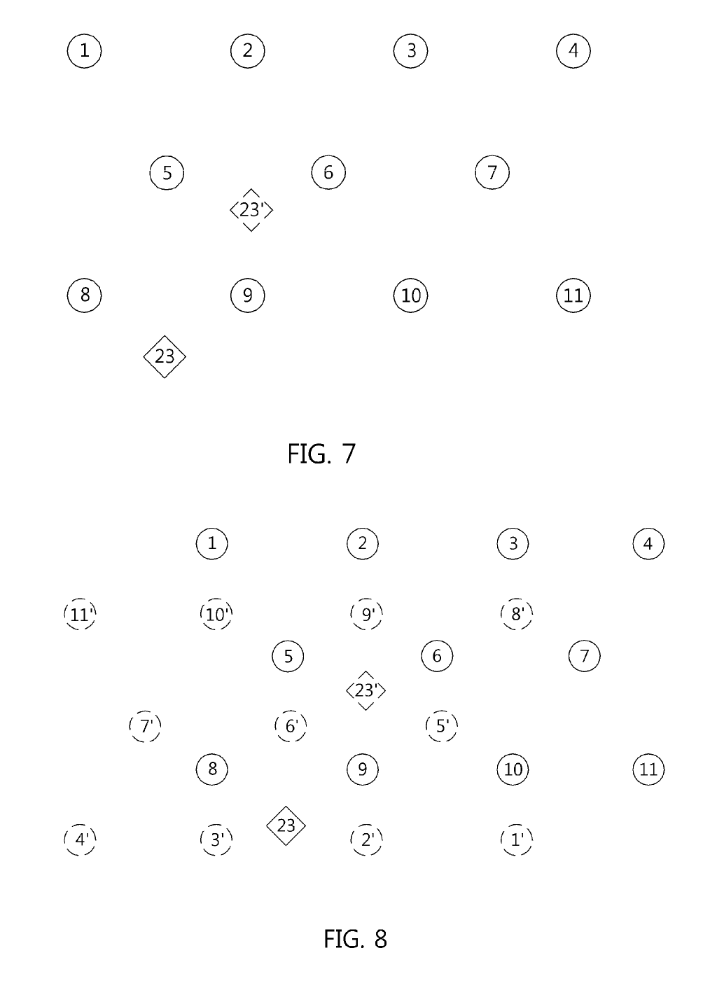

FIGS. 7 to 10 are diagrams showing an example of a process for estimating the location of a terminal by utilizing the method and apparatus for estimating the location of the terminal using the generation of virtual infrastructures according to the embodiment of the present invention.

In FIGS. 7 to 10, a process for estimating the location of a terminal by utilizing the method and apparatus for estimating the location of the terminal using the generation of virtual infrastructures according to the embodiment of the present invention will be described using the case of the terminal 23 as an example.

In FIG. 7, the terminal 23 is located outside an area enclosed by the actual installed infrastructures 1 to 11, but the location of the terminal 23 is estimated as a location within the area enclosed by the infrastructures if the existing location estimation method using weights relative to signal intensities is used. The location estimated in this way is the initially estimated location 23′ of the terminal 23. In this case, a method of calculating the initially estimated location 23′ can be implemented by considering various methods, such as a method of using an existing algorithm, a method of utilizing only the most suitable n infrastructures (for example, some infrastructures around the terminal), or a method of using only a single infrastructure.

In FIG. 8, virtual infrastructures 1′ to 11′ are generated by symmetrically moving the infrastructures 1 to 11, which are found by the terminal 23 and the locations of which are known, with respect to the initially estimated location 23′. In this case, the reason for generating the virtual infrastructures 1′ to 11′ through symmetrical movement is that it can be assumed that the locations and signal intensities of virtual infrastructures are identical to the locations and signal intensities of the infrastructures that have been symmetrically moved with respect to the actual location of the terminal 23.

Once the virtual infrastructures 1′ to 11′ have been generated, the location of the terminal 23 can be estimated using all of the actual infrastructures 1 to 11 that have been actually installed and the virtual infrastructures 1′ to 11′ that have been virtually generated.

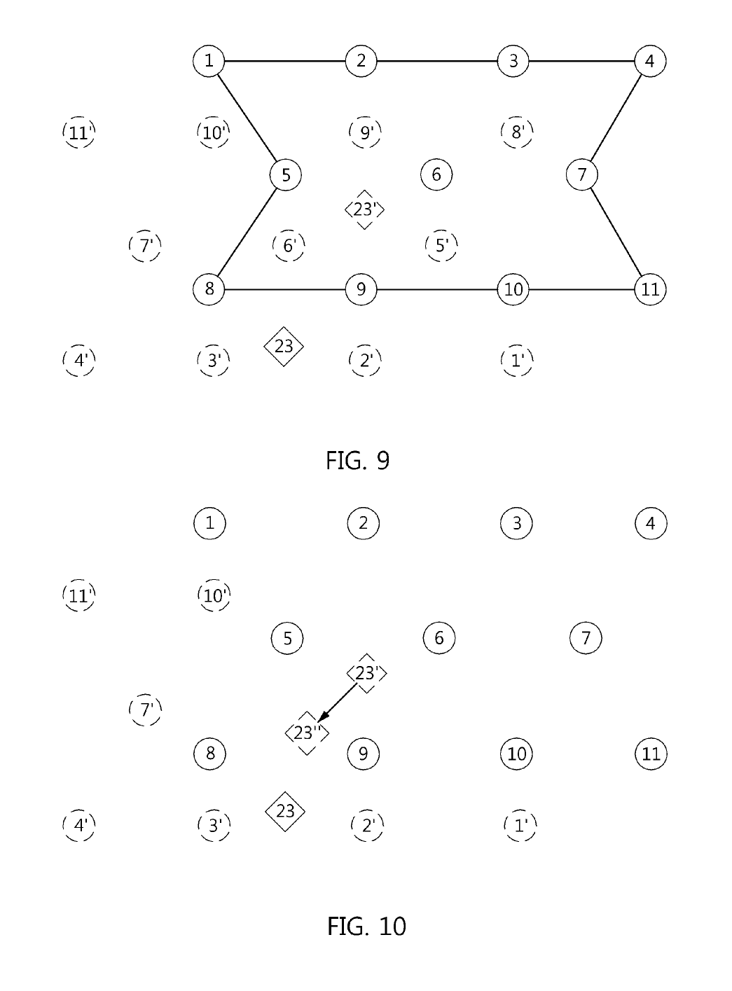

However, in another embodiment, a convex hull connecting the actual installed infrastructures 1 to 11 is configured, as shown in FIG. 9, so that the virtual infrastructures 5′, 6′, 8′, and 9′, the locations of which are included in the range of the convex hull, can be eliminated. The reason for performing this step is that when the virtual infrastructures 1′ to 11′ that have been virtually generated are enclosed by the actual installed infrastructures 1 to 11, the effect of reducing location errors is deteriorated.

FIG. 10 is a diagram showing a procedure in which the initially estimated location 23′ is corrected by combining the actual installed infrastructures 1 to 11 with the finally generated virtual infrastructures 1′, 2′, 3′, 4′, 7′, 10′, and 11′, and then the corrected estimated location 23″ of the terminal 23 is recalculated. It can be seen that the corrected estimated location 23″ of the terminal 23 is shifted to a location close to the actual location of the terminal, that is, the border of the corresponding area, via the effect of the terminal virtual infrastructures 1′, 2′, 3′, 4′, 7′, 10′, and 11′.

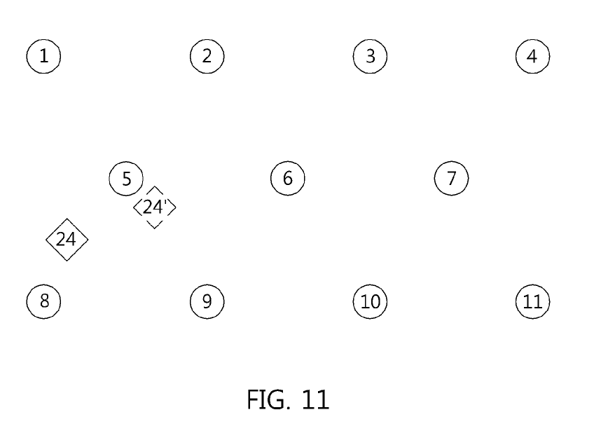

FIGS. 11 to 14 are diagrams showing another example of a process for estimating the location of a terminal by utilizing the method and apparatus for estimating the location of the terminal using the generation of virtual infrastructures according to the embodiment of the present invention.

In FIGS. 11 to 14, a process for estimating the location of a terminal by utilizing the method and apparatus for estimating the location of the terminal using the generation of virtual infrastructures according to the embodiment of the present invention will be described using the case of the terminal 24 as an example.

In FIG. 11, the terminal 24 is located outside an area enclosed by actual installed infrastructures 1 to 11, but the location of the terminal 24 is estimated as a location within the area enclosed by the infrastructures if the existing location estimation method using weights relative to signal intensities is used. The location estimated in this way is the initially estimated location 24′ of the terminal 24.

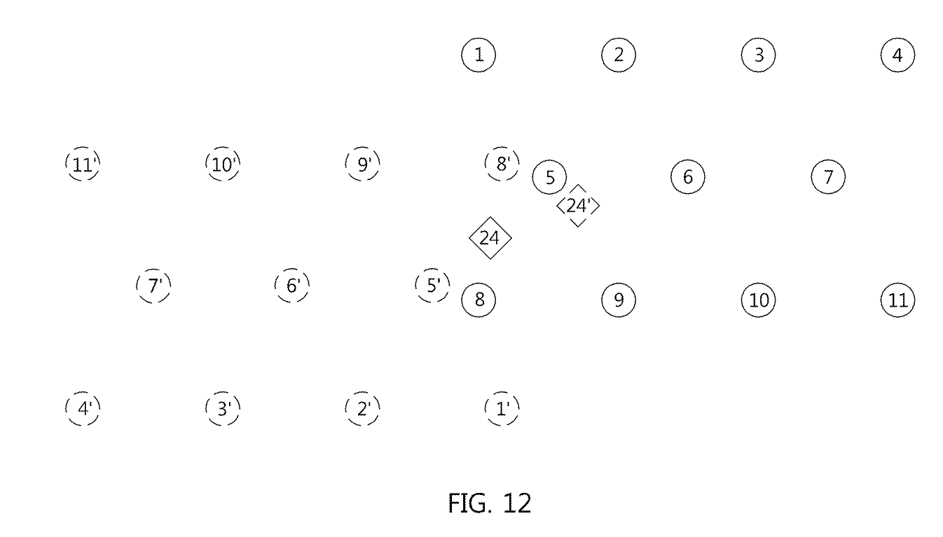

In FIG. 12, virtual infrastructures 1′ to 11′ are generated by symmetrically moving infrastructures 1 to 11, which are found by the terminal 24 and the locations of which are known, with respect to the initially estimated location 24′. In this case, the reason for generating the virtual infrastructures 1′ to 11′ through symmetrical movement is that it can be assumed that the locations and signal intensities of virtual infrastructures are identical to the locations and signal intensities of the infrastructures that have been symmetrically moved with respect to the actual location of the terminal 24.

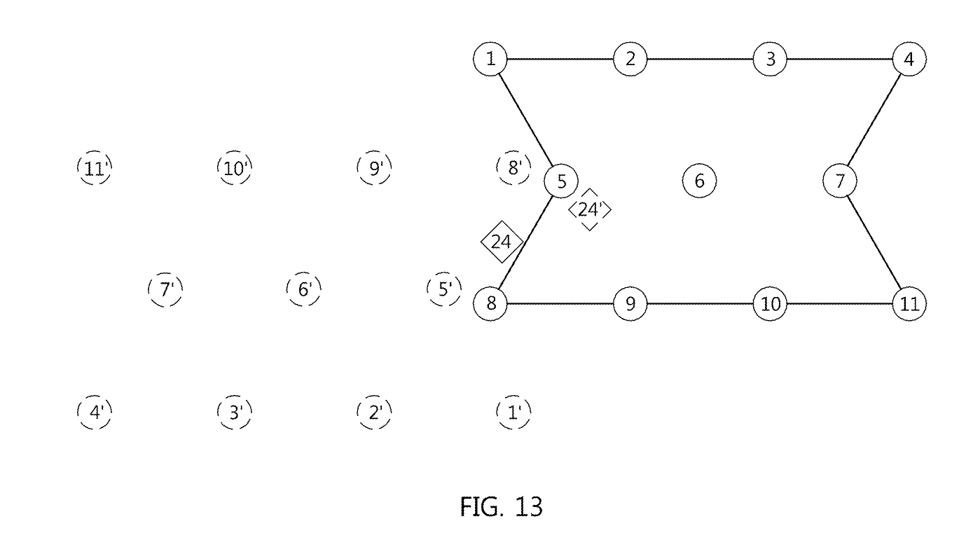

Unlike in FIG. 9, in FIG. 13, although a convex hull connecting actual installed infrastructures 1 to 11 is configured, there are no virtual infrastructures, the locations of which fall within the range of the convex hull, and so there is no need to separately eliminate virtual infrastructures.

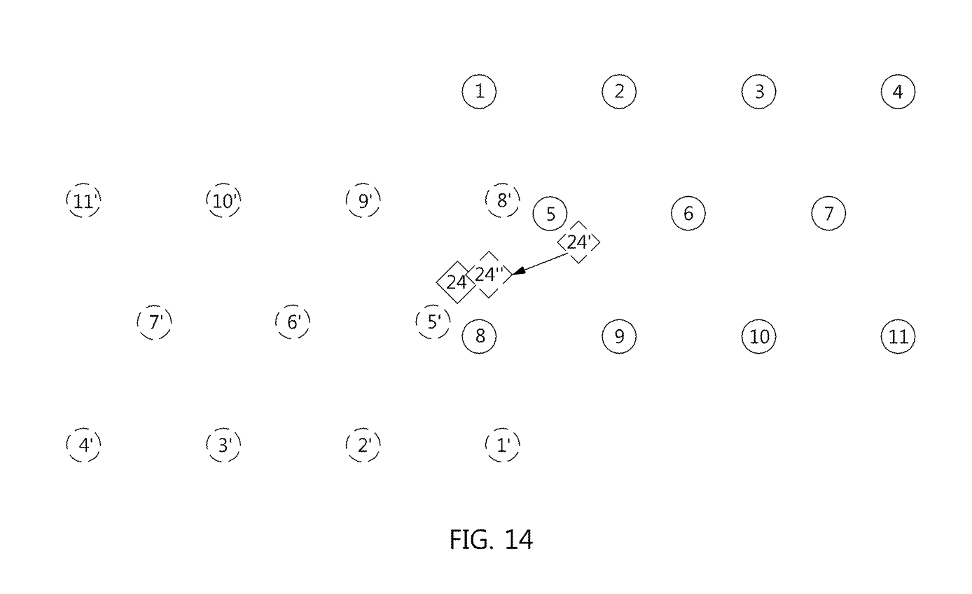

FIG. 14 is a diagram showing a procedure in which the initially estimated location 24′ is corrected by combining the actual installed infrastructures 1 to 11 with the finally generated virtual infrastructures 1′ to 11′, and then the corrected estimated location 24″ of the terminal 24 is recalculated. It can be seen that the corrected estimated location 24″ of the terminal 24 is shifted to a location close to the actual location of the terminal 24 via the effect of the virtual infrastructures 1′ to 11′.

In accordance with an aspect of the present invention, there can be provided a method and apparatus for estimating the location of a terminal using the generation of virtual infrastructures, which generate a plurality of virtual infrastructures and calculate a more accurate location by complexly utilizing the virtual infrastructures and information about actual installed infrastructures when estimating the location based on the signal intensities of the infrastructures, so that when the terminal is located in a border area defined by the infrastructures or the outer area thereof, more precise location accuracy can be simply obtained by merely revising an algorithm without installing an additional infrastructure or modifying a distance measurement method or the like.

As described above, although specific embodiments of the present invention have been illustrated and described, those skilled in the art will appreciate that various modifications, additions and substitutions are possible, without departing from the scope and spirit of the invention as disclosed in the accompanying claims. Therefore, the technical scope of the present invention should be defined by the technical spirit of the claims.

What is claimed is:

1. A method of estimating a location of a terminal using generation of virtual infrastructures, comprising:
calculating an initially estimated location of a terminal using a plurality of installed infrastructures;
generating a plurality of virtual infrastructures by symmetrically moving the plurality of infrastructures with respect to the initially estimated location of the terminal; and
correcting the initially estimated location of the terminal using the plurality of infrastructures and the plurality of virtual infrastructures, and then recalculating the corrected estimated location of the terminal.

2. The method of claim 1, further comprising, eliminating virtual infrastructures enclosed by the plurality of infrastructures from the plurality of virtual infrastructures.

3. The method of claim 2, wherein the recalculating the corrected estimated location of the terminal is configured to correct the initially estimated location of the terminal using the plurality of infrastructures and virtual infrastructures, except the eliminated virtual infrastructures among the plurality of virtual infrastructures, and then recalculate the corrected estimated location of the terminal.

4. The method of claim 1, wherein the calculating the initially estimated location of the terminal is configured to calculate the initially estimated location of the terminal either by using only some infrastructures around the terminal among the plurality of infrastructures or by using only one infrastructure among the plurality of infrastructures.

5. An apparatus for estimating a location of a terminal using generation of virtual infrastructures, comprising:
an initially estimated location calculation unit for calculating an initially estimated location of the terminal using a plurality of installed infrastructures;
a virtual infrastructure generation unit for generating a plurality of virtual infrastructures by symmetrically moving the plurality of infrastructures with respect to the initially estimated location of the terminal; and
a corrected estimated location calculation unit for correcting the initially estimated location of the terminal using the plurality of infrastructures and the plurality of virtual infrastructures, and then recalculating the corrected estimated location of the terminal.

6. The apparatus of claim 5, wherein the virtual infrastructure generation unit eliminates virtual infrastructures enclosed by the plurality of infrastructures from the plurality of virtual infrastructures.

7. The apparatus of claim 6, wherein the corrected estimated location calculation unit corrects the initially estimated location of the terminal using the plurality of infrastructures and virtual infrastructures, except the eliminated virtual infrastructures among the plurality of virtual infrastructures, and then recalculates the corrected estimated location of the terminal.

8. The apparatus of claim 5, wherein the initially estimated location calculation unit calculates the initially estimated location of the terminal either by using only some infrastructures around the terminal among the plurality of infrastructures or by using only one infrastructure among the plurality of infrastructures.

9. The apparatus of claim 5, wherein the plurality of infrastructures are Wi-Fi access points.
